(19) United States
(12) Patent Application Publication
(10) Pub. No.: US 2015/0157949 A1
(43) Pub. Date: Jun. 11, 2015

(54) GAMING CONTROLLER THUMB GLOVE INTERFACE

(71) Applicant: Robert Gordon DURLING, JR., Shelby Township, MI (US)

(72) Inventor: Robert Gordon DURLING, JR., Shelby Township, MI (US)

(21) Appl. No.: 14/627,150

(22) Filed: Feb. 20, 2015

Related U.S. Application Data
(63) Continuation-in-part of application No. 14/142,630, filed on Dec. 27, 2013.
(60) Provisional application No. 61/746,515, filed on Dec. 27, 2012.

(51) Int. Cl. A63F 13/98; A63F 13/24

(52) U.S. Cl. CPC A63F 13/98; A63F 13/24

(57) ABSTRACT

A gaming controller thumb glove interface may include a wrist strap that has a first end and a second end. The first end may attach to the second end of the wrist strap by fasteners. A thumb pocket may have a top end and a bottom end. The bottom end of the thumb pocket may attach to the wrist strap. A controller component interface may be attached to the top end of the thumb pocket. In certain embodiments, a pull tab may be attached to the bottom end of the thumb pocket. A controller cap such as a thumb stick cap, a D-pad cap and the like may attach to a controller thumb stick, a controller D-pad and the like. The controller component interface may removably attach to the controller cap for maneuvering the components of the controller through leverage.

### CROSS-REFERENCE TO RELATED APPLICATION

This application is a continuation in part of U.S. non-provisional application Ser. No. 14/142,630, filed Dec. 27, 2013 and claims the benefit of U.S. provisional application No. 61/746,515, filed Dec. 27, 2012, the contents of which are herein incorporated by reference.

### BACKGROUND OF THE INVENTION

The present invention relates to gaming gloves and, more particularly, to a gaming controller thumb glove interface.

While using video games and video game controllers, an individual's thumbs may become sore from the repetitive motion. Other conditions include gamer thumb, repetitive strain or stress injury and de Quervain syndrome may occur through the use of gaming controllers. Currently, gaming gloves on the market only cover the thumb and do not connect to the controller thumb stick. There are also thumb stick caps that apply to the controller thumb stick but do not connect to the thumb. Both of these types of products do not allow for maneuvering through leverage instead of pressure.

As can be seen, there is a need for a gaming controller thumb glove interface that allows for maneuvering of components of a controller through leverage.

### SUMMARY OF THE INVENTION

In one aspect of the present invention, a gaming controller thumb glove comprises: a wrist strap securable to a wrist; a thumb pocket attached to the wrist strap and sized to receive a thumb therein; a first magnetic material attached to the thumb pocket at a distal end; and a controller cap comprising a second magnetic material attracted to the first magnetic material, wherein the controller cap is attachable to a video game controller component.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention being placed for use;

FIG. 3 is an exploded view of an exemplary embodiment of the present invention securing a wrist strap;

FIG. 4 is a perspective view of an exemplary embodiment of the present invention in use;

FIG. 5 is an exploded view of an exemplary embodiment of the present invention demonstrating the application of a controller component cap to a controller thumb stick of an exemplary controller;

FIG. 6 is a perspective view of an exemplary embodiment of the present invention demonstrating interface;

FIG. 7 is a perspective view of an exemplary embodiment of the present invention demonstrating interface;

FIG. 8 is a top view of an exemplary embodiment of the present invention;

FIG. 9 is a bottom view of an exemplary embodiment of the present invention;

FIG. 10 is a side view of an exemplary embodiment of the present invention;

FIG. 11 is a section view of an exemplary embodiment of the present invention along line 11-11 in FIG. 7;

FIG. 12 is a front view of an alternate embodiment of the present invention;

FIG. 13 is a top view of an alternate embodiment of the present invention;

FIG. 14 is a front view of an alternate embodiment of the present invention in use;

FIG. 15 is a top view of an alternate embodiment of the present invention;

FIG. 16 is a side view of an alternate embodiment of the present invention;

FIG. 17 is an exploded view of an alternate embodiment of the present invention demonstrating the application of a controller component cap to an a controller D-pad of an exemplary controller;

FIG. 18 is a perspective view of an alternate embodiment of the present invention demonstrating interface;

FIG. 19 is a perspective view of an embodiment of the present invention;

FIG. 20 is a section detail view of an embodiment of the present invention along line 20-20 in FIG. 19;

FIG. 21 is an exploded view of an embodiment of the present invention; and

FIG. 22 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gaming controller thumb glove interface that may include a wrist strap that has a first end and a second end. The first end may attach to the second end of the wrist strap by fasteners. A thumb pocket may have a top end and a bottom end. The bottom end of the thumb pocket may attach to the wrist strap. A controller component interface may be attached to the top end of the thumb pocket. In certain embodiments, a pull tab may be attached to the bottom end of the thumb pocket. A controller cap such as a thumb stick cap, a D-pad cap and the like may attach to a controller thumb stick, a controller D-pad and the like. The controller component interface may removably attach to the controller cap for maneuvering the components of the controller.

The present invention may be a snap in device that may use leverage for gaming controller components such as controller thumb sticks and controller D-pads by connecting a controller component interface to a controller cap attached to the controller thumb stick, controller D-pad and the like. The leverage use instead of pressure may relieve thumb pain that may lead to other problems such as gamer thumb and de Quervain syndrome. Using leverage may also increase operator performance and maneuverability to advance the overall gamer experience.

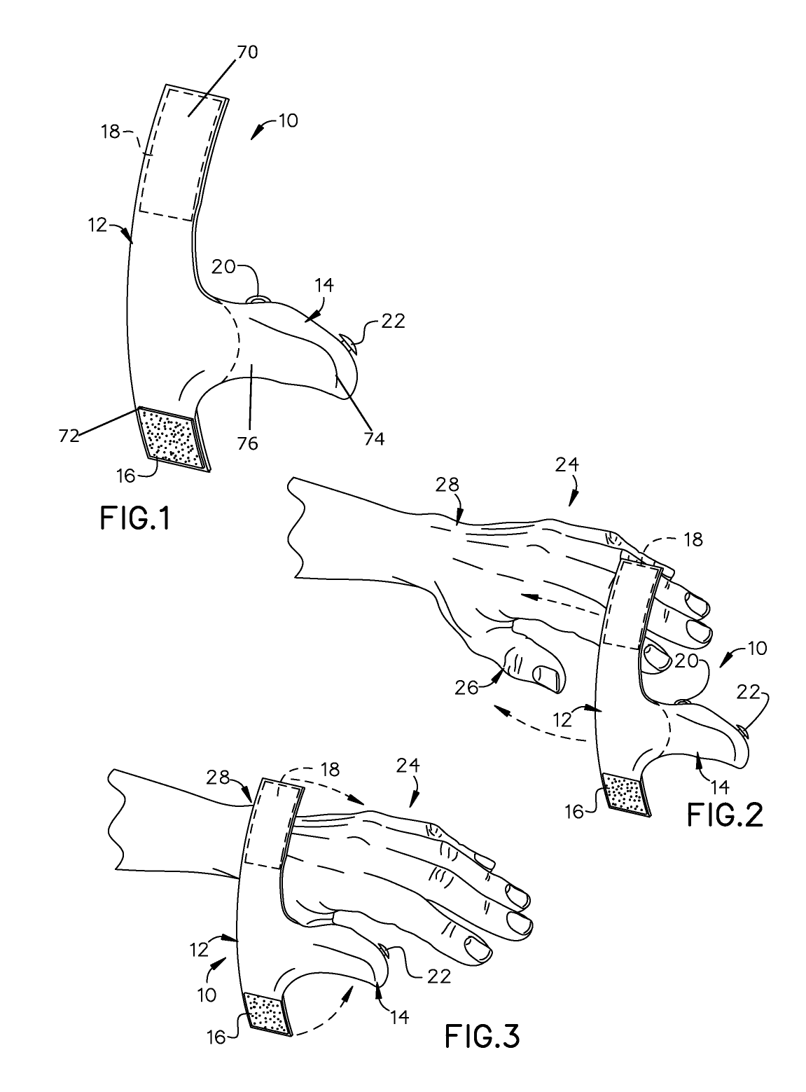

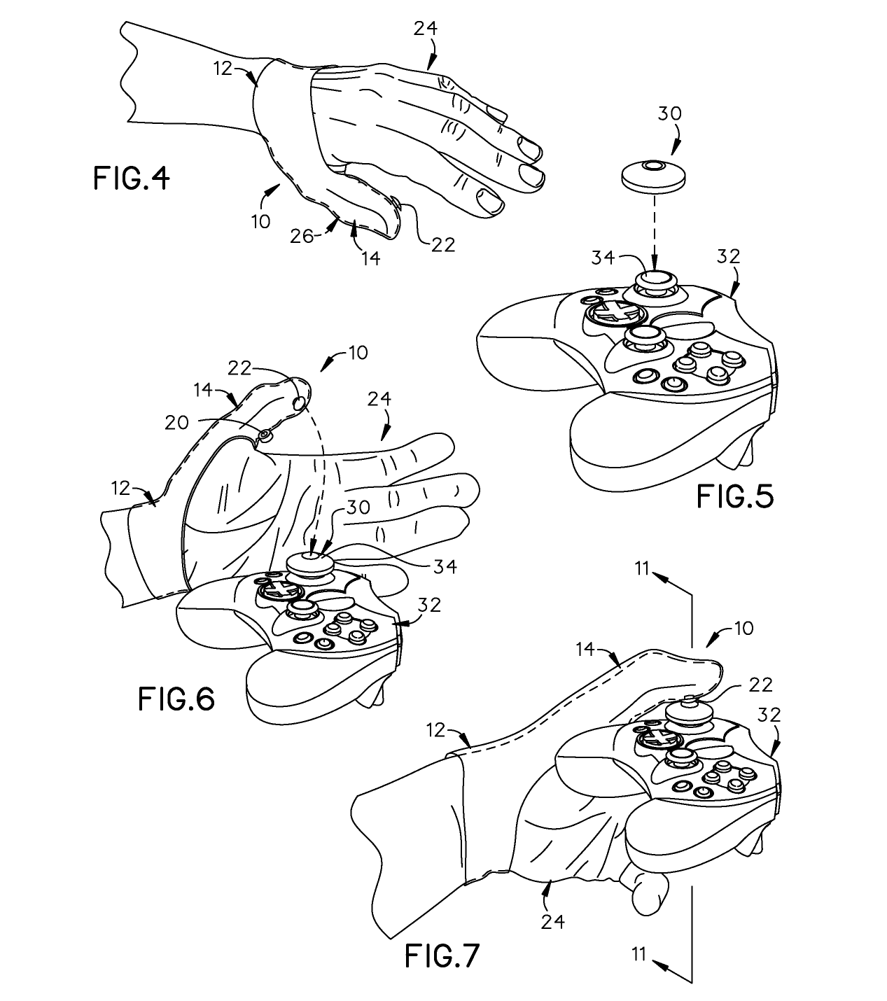

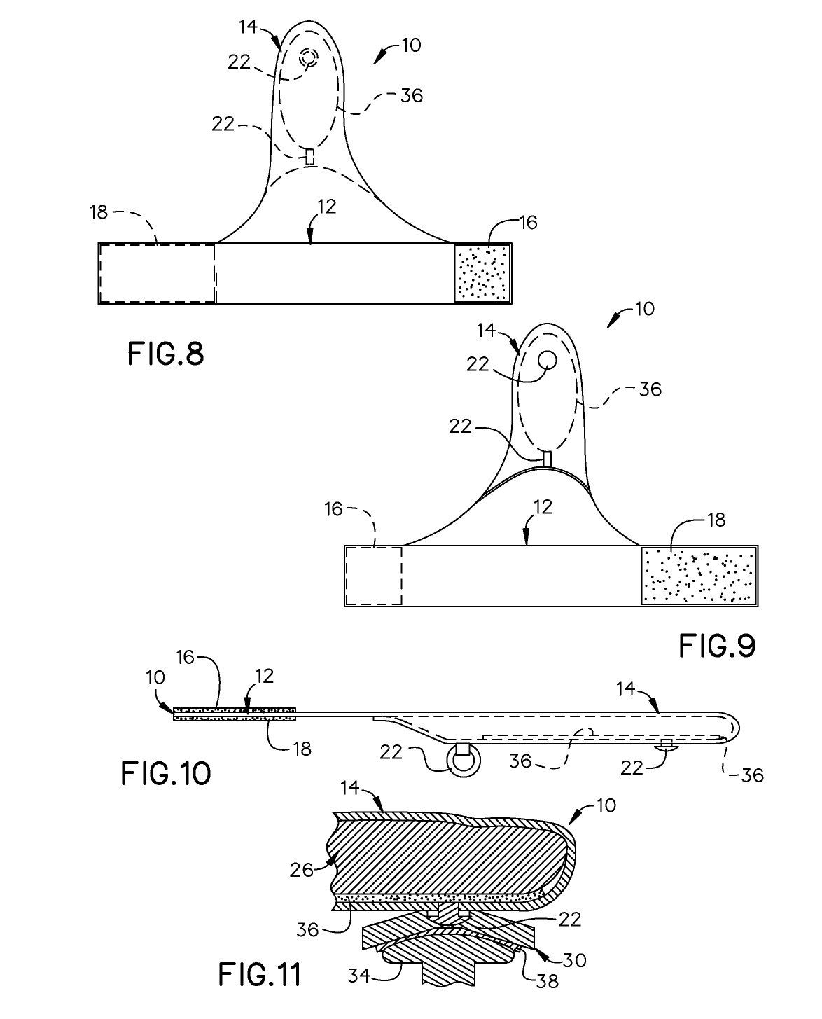

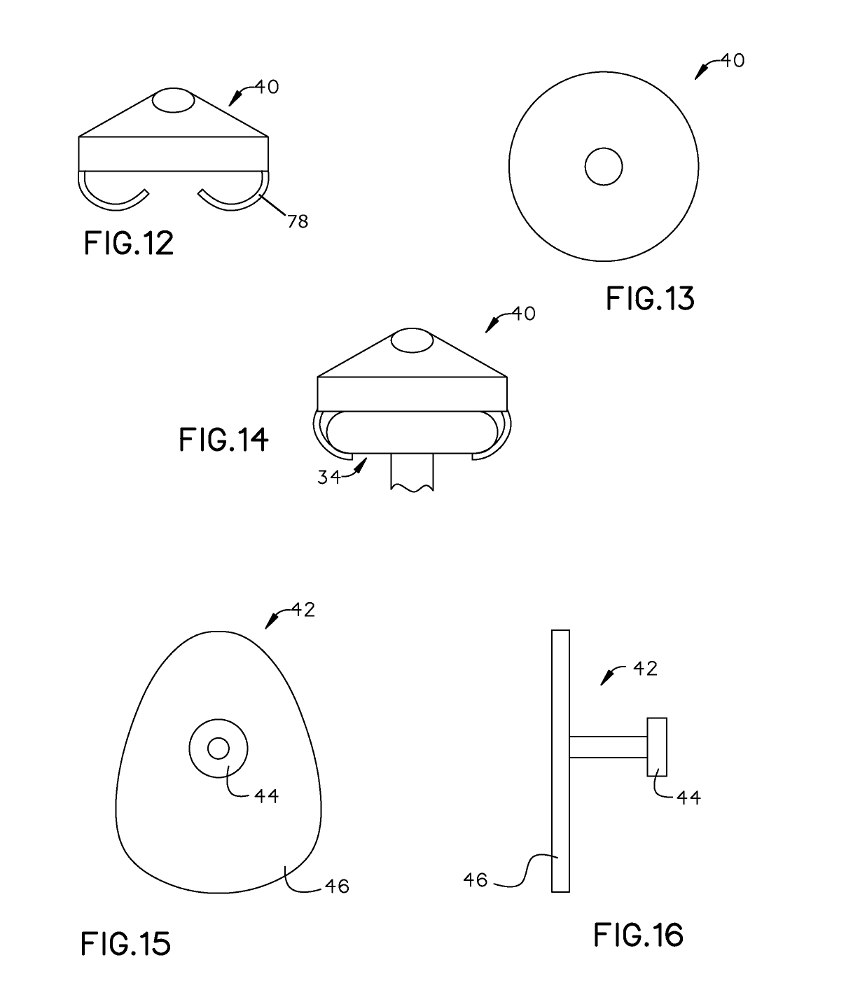

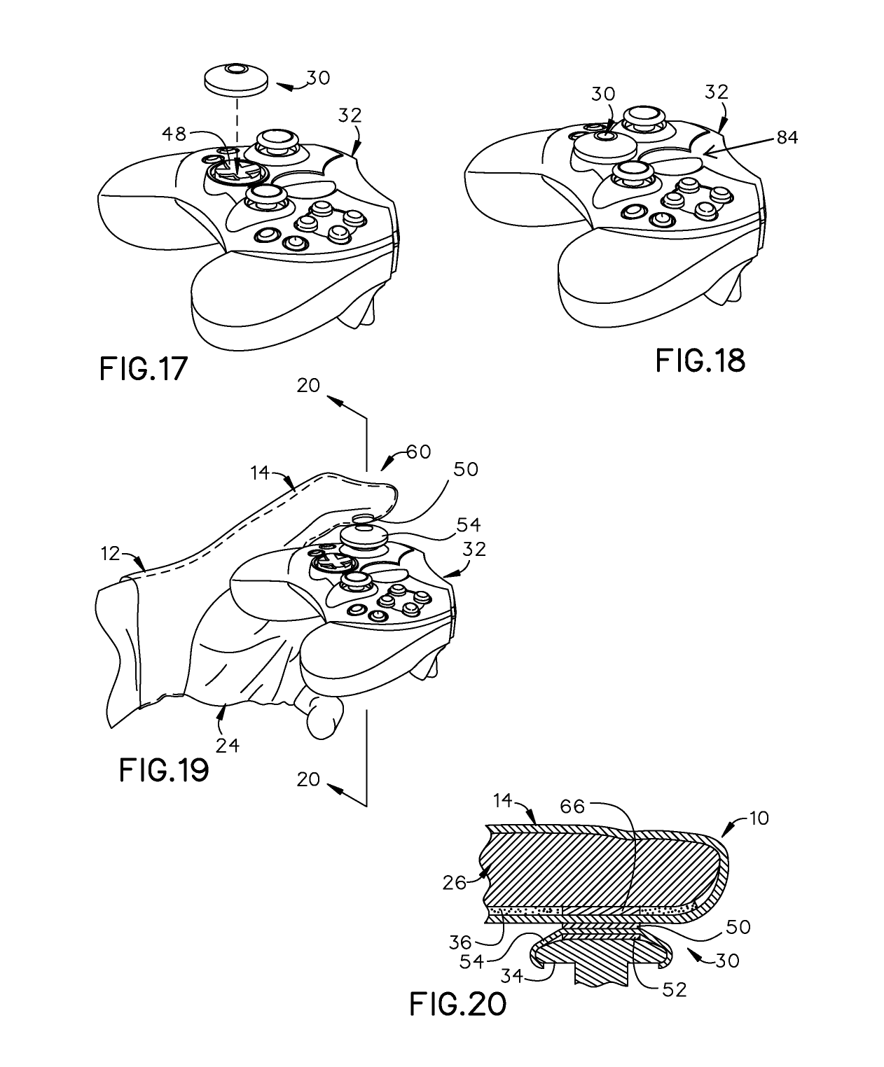

As is illustrated in FIGS. 1 through 18, the gaming controller thumb glove interface 10 may include a wrist strap 12. The wrist strap 12 may have a first end 70 and a second end 72. The wrist strap may have a first fastener 16 along the first end 70 and a second fastener 18 along the second end 72. In certain embodiments, the first fastener 16 and the second fastener 18 may allow for the first end 70 to attach to the second end 72. In certain embodiments, the first fastener 16 and the second fastener 18 may be a hook and latch fastener. A thumb pocket 14 may be attached to the wrist strap 12. The thumb pocket 14 may have a top end 74 (distal) and a bottom end 76 (proximal). Along the top end 74 of the thumb pocket 14 may be a controller component interface 42. In certain embodiments, a pull tab 20 may be attached to the bottom end 76 of the thumb pocket 14.

In certain embodiments, the controller component interface 42 may be a connector tab 22. In certain embodiments, the controller component interface 42 may be the connector tab 22 attached to a thumb tip patch 36. In certain embodiments, an alternate thumb tip patch 46 may be used. The alternate thumb tip patch 46 may be made from a plastic or the like. An alternate connector tab 44 may also be used in certain embodiments depending on the type of controller 32 being used.

In certain embodiments, a controller component cap 30 may be attached to a controller component 84. The controller component 84 may be a controller thumb stick 34, a controller D-pad 48, and the like. In certain embodiments, the controller component cap 30 may be attached to a controller thumb stick 34 of a controller 32. In certain embodiments, the controller component cap 30 may be attached to a controller D-pad 48. In certain embodiments, an alternate controller component cap 40 may be used that has a mushroom shaped body with latches 78 along a bottom portion of the alternate controller component cap 40 that allow for gripping and attaching to a controller thumb stick 34 by snapping into place.

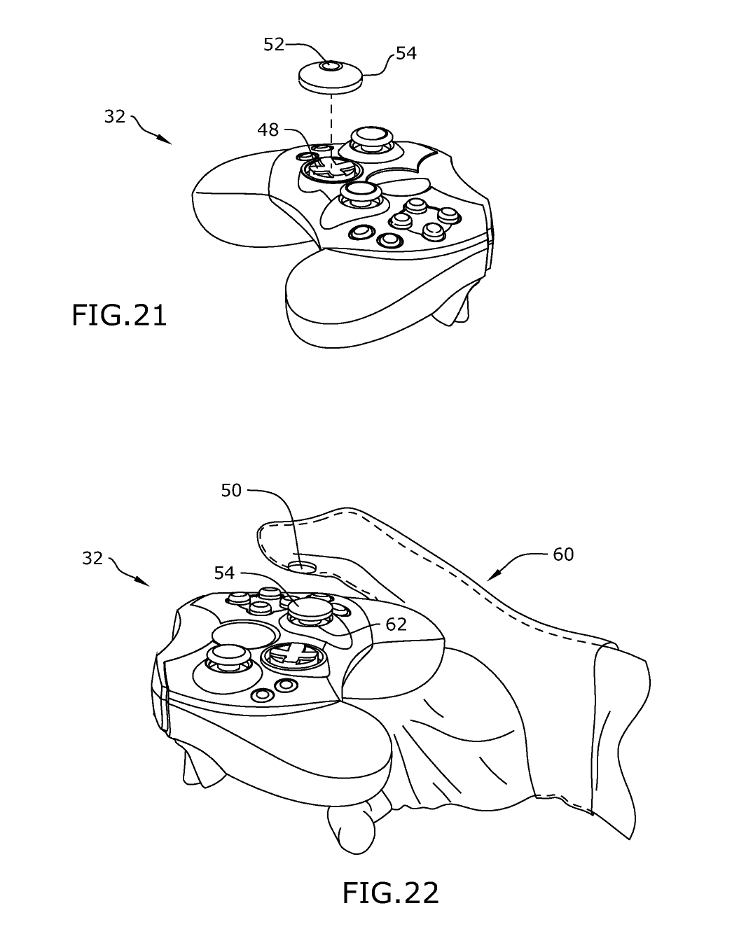

Referring to FIGS. 19 through 22, the present invention may include an alternate gaming controller thumb glove interface 60. In such embodiments, the controller component interface 42 may include a glove magnet 50. The alternate gaming controller thumb glove interface 60 may include an inner thumb tip patch magnet 66 and an outer magnet 50. A magnetic controller component cap 54 includes a magnet 52 that is attracted to at least the outer magnet 50. The cap 54 may attach to the controller thumb stick 34 including the right or the left controller thumb stick 62. Alternatively, the magnetic controller component cap 54 may secure to the controller D-Pad 48. The glove magnet 50 may releasably connect with the magnetic controller component cap 54 in order to use the controller 32.

A method of using the gaming controller thumb glove interface 10 may include the following. An operator may secure the controller component cap 30 in the approximate center of the controller thumb stick 34 on a controller 32. In certain embodiments, the operator may secure the controller component cap 30 in the approximate center of the controller D-pad 48 on the controller 32. The controller component cap 30 may be attached by an adhesive 38. The operator may place the thumb pocket 14 around an operator thumb 26 along an operator hand 24. In certain embodiments, the operator may pull the thumb pocket 14 into a comfortable position around the operator thumb 26 by pulling on the pull tab 20. Once the thumb pocket 14 may be in position, the wrist strap 12 may be secured as well around an operator wrist 28. In certain embodiments, the wrist strap 12 may be made from a nylon/spandex blend or the like. In certain embodiments, the nylon/spandex blend may be in a ratio of approximately 48 percent/18 percent. The first end 70 may be attached to the second end 72 to hold the wrist strap 12 and thumb pocket 14 in place. The operator may connect the controller component interface 42 to the thumb stick cap 30. In certain embodiments, the connector tab 22 may be pressed into the approximate center of the hole in the thumb stick cap 30. The operator may be ready to play by controlling the controller thumb stick 34 with leverage. Less pressure is required of the operator thumb 26 to maneuver the controller thumb stick 34 with the gaming controller thumb glove interface 10 than with just the operator hand 24 alone. The operator may have support and comfort while using the controller 32 with the gaming controller thumb glove interface 10. Reducing pressure of the operator thumb 26 may reduce pain levels which may allow for comfort which in turn may increase performance while playing games. The operator may be able to snap the controller component interface 42 in and out of the controller component cap 30 between play.

It should be understood, of course, that the foregoing relates to exemplary embodiments of the invention and that modifications may be made without departing from the spirit and scope of the invention as set forth in the following claims.

What is claimed is:

1. A gaming controller thumb glove comprising:
a wrist strap securable to a wrist;
a thumb pocket attached to the wrist strap and sized to receive a thumb therein;
a first magnetic material attached to the thumb pocket at a distal end; and
a controller cap comprising a second magnetic material attracted to the first magnetic material, wherein the controller cap is attachable to a video game controller component.

2. The gaming controller thumb glove 1, wherein the wrist strap comprises a first end and a second end opposite the first end, wherein the first end and second end are releasably attachable.

3. The gaming controller thumb glove 2, wherein the first end and the second end are releasably attachable by a hook and loop fastener.

4. The gaming controller thumb glove 1, wherein the video game controller component is at least one of a D-pad and a joystick.

5. The gaming controller thumb glove of claim 1, wherein the controller cap comprises a latch releasably attachable to the video game controller component.

6. The gaming controller thumb glove of claim 1, further comprising a pull tab attached to the thumb pocket on a proximal end.

7. The gaming controller thumb glove of claim 1, wherein the first magnetic material is a first magnet and the second magnetic material is a second magnet, wherein the first magnet and the second magnet comprise opposite polarity.
